(19) United States
(12) Patent Application Publication
(10) Pub. No.: US 2024/0161608 A1
(43) Pub. Date: May 16, 2024

(54) ACCIDENT INFORMATION COLLECTION AND PROCESSING METHOD AND VEHICLE OPERATION CONTROL SERVER USING THE SAME

(71) Applicants: Hyundai Motor Company, Seoul (KR); Kia Corporation, Seoul (KR)

(72) Inventor: Minwoo Lee, Anyang-Si (KR)

(21) Appl. No.: 18/234,962

(22) Filed: Aug. 17, 2023

(30) Foreign Application Priority Data
Nov. 16, 2022 (KR) 10-2022-0153713

(51) Int. Cl. G08G 1/01

(52) U.S. Cl. CPC G08G 1/0141; G08G 1/0112; G08G 1/0133

(57) ABSTRACT

A server is provided for vehicle operation control. The server may collect, from one or more vehicles in a road section, event data regarding a traffic accident associated with a road section; determine, based on the event data and among the one or more vehicles, a quantity of vehicles that had at least one airbag deployed in connection with the traffic accident; determine, based on the quantity of the vehicles that had at least one airbag deployed in connection with the traffic accident, an accident severity value indicating seriousness of the traffic accident; transmit, based on the accident severity value, a notification to a trailing vehicle; and collect, based on a determination that the accident severity value satisfies a threshold value, additional information associated with the traffic accident.

### CROSS-REFERENCE TO RELATED APPLICATION

This application claims priority to and the benefit of Korean Patent Application No. 10-2022-0153713 filed in the Korean Intellectual Property Office on Nov. 16, 2022, the entire contents of which are incorporated herein by reference.

### BACKGROUND

### (a) Field

The present disclosure relates to an accident information collection and processing method and a vehicle operation control server using the same.

### (b) Description of the Related Art

When a vehicle accident such as vehicle collision occurs on the road, congestion may occur on the road on a route from the point of the accident to a destination. After the accident, a secondary accident may be caused by a trailing vehicle that fails to recognize the accident or the slowed-down traffic in advance.

Even though the accident on the road may be notified by a route guidance application, such an accident notification may be reliant on the accident being discovered or reported by a person involved in the accident. Accordingly, if the party involved in the accident cannot report the accident or no one discovers the accident, no report may be made, and it may be difficult for the trailing vehicles to recognize the accident.

The above information disclosed in this Background section is only for enhancement of understanding of the background of the present disclosure, and therefore it may contain information that does not form the prior art that is already known in this country to a person of ordinary skill in the art.

### SUMMARY

The present disclosure has been made in an effort to provide an accident information collection and processing method and a vehicle operation control server using the same.

According to one or more example embodiments of the present disclosure, a server device may include: a communication device configured to exchange, via a network, information with a vehicle; one or more processors; and memory. The memory may store instructions that, when executed by the one or more processors, cause the server device to: collect, via the communication device and from one or more vehicles in a road section, event data regarding a traffic accident associated with the road section; determine, based on the event data and among the one or more vehicles, a quantity of vehicles that had at least one airbag deployed in connection with the traffic accident; determine, based on the quantity of the vehicles that had at least one airbag deployed in connection with the traffic accident, an accident severity value indicating seriousness of the traffic accident; transmit, via the communication device and based on the accident severity value, a notification to a trailing vehicle that trails behind the one or more vehicles; and collect, based on a determination that the accident severity value satisfies a threshold value, additional information associated with the traffic accident.

To collect the event data, the instructions, when executed by the one or more processors, may cause the server device to: divide, based on link data for one or more roads, one or more roads into a plurality of road sections; determine, among the plurality of road sections, the road section on which the traffic accident occurred; and determine a quantity of the one or more vehicles in the road section.

The instructions, when executed by the one or more processors, may cause the server device to: search, among the one or more vehicles in the road section, for a vehicle that encounters the traffic accident during a predetermined search period.

The instructions, when executed by the one or more processors, may cause the server device to determine the accident severity value further based on at least one of: the quantity of the one or more vehicles in the road section, a quantity of vehicles that decelerated at a rate above a threshold deceleration rate, or a quantity of vehicles with an operation time of an electronic stability control (ESC) device above a threshold time duration.

The instructions, when executed by the one or more processors, may cause the server device to determine the accident severity value further based on additional event data from one or more additional vehicles in additional road sections that are adjacent to the road section.

The instructions, when executed by the one or more processors, may further cause the server device to determine the road section based on location information of the one or more vehicles.

The additional information associated with the traffic accident may include at least one of: image data associated with the one or more vehicles, driving-related control data associated with the one or more vehicles, or image data associated with vehicles adjacent to the one or more vehicles.

The instructions, when executed by the one or more processors, may further cause the server device to estimate, based on the quantity of vehicles that had at least one airbag deployed in connection with the traffic accident, a scale of the traffic accident.

The instructions, when executed by the one or more processors, may further cause the server device to, based on the accident severity value being greater than a second threshold value: transmit, to the trailing vehicle, an accident section notification indicating the road section, and an image associated with the traffic accident; search for a detour path around the road section; and transmit, via the communication device, the searched detour path to the trailing vehicle.

The instructions, when executed by the one or more processors, may further cause the server device to, based on the accident severity value being less than a second threshold value, transmit, via the communication device and to the trailing vehicle: an accident notification indicating occurrence of the traffic accident, and an accident section notification indicating the road section.

The communication device may be further configured to receive recorded data from an audio video navigation telematics (AVNT) device of each of the one or more vehicles.

According to one or more example embodiments of the present disclosure, a method may include: receiving, by a server device and from one or more vehicles, a signal indicating a traffic accident, the signal comprising event data generated by a respective event data recorder of each of the one or more vehicles; determining, based on the signal, one or more road sections where the traffic accident occurred; determining, based on a location of the traffic accident, a quantity of vehicles, of the one or more vehicles, in at least one road section of the one or more road sections; determining, based on the event data and the quantity of the vehicles in the at least one road section, an accident severity value indicating seriousness of the traffic accident; determining, based on the accident severity value, whether to collect additional information associated with the traffic accident; estimating, based on a quantity of vehicles whose airbags were deployed, a scale of the traffic accident; and transmitting, based on the estimated scale of the traffic accident, a notification, associated with the traffic accident, to a trailing vehicle that trails behind the one or more vehicles.

Determining the quantity of the vehicles in the at least one road section may include: dividing, based on link data for one or more roads, the one or more roads into the road sections; determining, among the road sections, the at least one road section in which the traffic accident occurred; and determining the quantity of the vehicles in the at least one road section.

Determining the quantity of the vehicles in the at least one road section may include: searching, among the one or more vehicles in the at least one road section, for a vehicle that encounters the traffic accident during a predetermined search period.

Determining the accident severity value may include: determining the accident severity value further based on at least one of: the quantity of vehicles whose airbags were deployed, a quantity of vehicles that decelerated at a rate above a threshold deceleration rate, or a quantity of vehicles with an operation time of an electronic stability control (ESC) device above a threshold time duration.

The method may further include: based on determining to collect the additional information, requesting the one or more vehicles and at least one adjacent vehicle for the additional information.

The additional information associated with the traffic accident may include at least one of: image data associated with the one or more vehicles, driving-related control data associated with the one or more vehicles, or image data associated with vehicles adjacent to the one or more vehicles.

The notification may include, based on the estimated scale of the traffic accident being less than a second threshold value, an indication of the traffic accident and an indication of the at least one road section.

The notification may include, based on the estimated scale of the traffic accident being greater than or equal to a second threshold value: an indication of the at least one road section and an image associated with the traffic accident. The method may further include: searching for a detour path around the at least one road section; and transmitting the searched detour path to the trailing vehicle.

According to the accident information collection and processing method and the vehicle operation control server using the same, image data at the time of the accident and before/after the accident may be remotely collected by the server from a vehicle which is directly involved in the accident or a vehicle which is driving or driven a car accident-occurring section to identify the accident situation to be utilized for analysis of causes of the accident.

In many cases, it may not be easy to analyze the cause of the accident due to the fact that the accident vehicle is not equipped with a built-in cam or navigation system, and related parts may be damaged so that it is difficult to obtain data to determine the accident situation in various life/vehicle accident situations caused by the vehicle. According to the accident information collection and processing method and the vehicle operation control server using the same, image data in the vicinity of the scene of the accident is acquired from other vehicles rather than the accident vehicle to be utilized for analysis of causes of the accident.

The severity of the collision accident may be determined using an accident recording device to determine whether additional data collection is necessary, determine the scale of the collision and inform the driver to reduce the risk of secondary accidents of the driver, and if the severity of the collision is serious, a detour route may be provided to improve the driver's satisfaction in using the system.

### BRIEF DESCRIPTION OF THE DRAWINGS

FIG. 1 is a configuration of a server.

FIGS. 2A and 2B are flowcharts illustrating an operation of a vehicle operation control server.

FIG. 3 is a flowchart illustrating an accident information processing method of a server.

### DETAILED DESCRIPTION

In order to sufficiently understand the present disclosure and objects achieved by carrying out the present disclosure, accompanying drawings which illustrate one or more example embodiments of the present disclosure and description of the accompanying drawing need to be referenced.

Hereinafter, the one or more example embodiments of the present disclosure will be described in detail with reference to the accompanying drawings. In describing the present specification, when it is determined that a detailed description of a related publicly known technology or function may obscure the gist of the present specification, the detailed description thereof will be omitted. Like reference numeral proposed in each drawing denotes like constituent elements.

The terms used in the present specification are used to describe a specific example embodiment, but are not intended to limit the present disclosure. A singular form may include a plural form if there is no clearly opposite meaning in the context

In the present disclosure, it should be understood that terminology “include” or “have” indicates that a feature, a number, a step, an operation, a component, a part or the combination thereof described in the specification is present, but do not exclude a possibility of presence or addition of one or more other features, numbers, steps, operations, components, parts or combinations, in advance.

Throughout this specification and the claims that follow, when it is described that a part is “coupled” to another part, the part may be “directly coupled” to the other part or “electrically coupled” to the other element through a third element.

Unless otherwise defined, all terms used herein including technological or scientific terms have the same meaning as those generally understood by a person with ordinary skill in the art. Terms which are defined in a generally used dictionary should be interpreted to have the same meaning as the meaning in the context of the related art but are not interpreted as an ideally or excessively formal meaning if it is not clearly defined in the present disclosure.

Among configurations according to one or more example embodiments, in a configuration which controls the other configuration in a specific control condition, a program implemented by a set of instructions in which a control algorithm required to control the other configuration is implemented may be installed. The control configuration may process input data and stored data according to the installed program to generate output data. The control configuration may include a nonvolatile memory which stores a program and a memory which stores data.

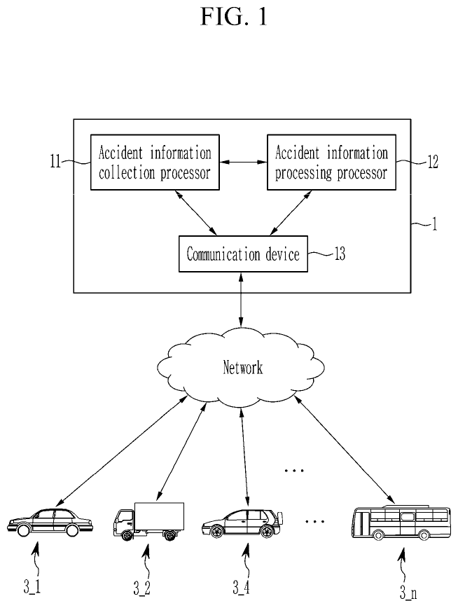

FIG. 1 is a configuration of a server.

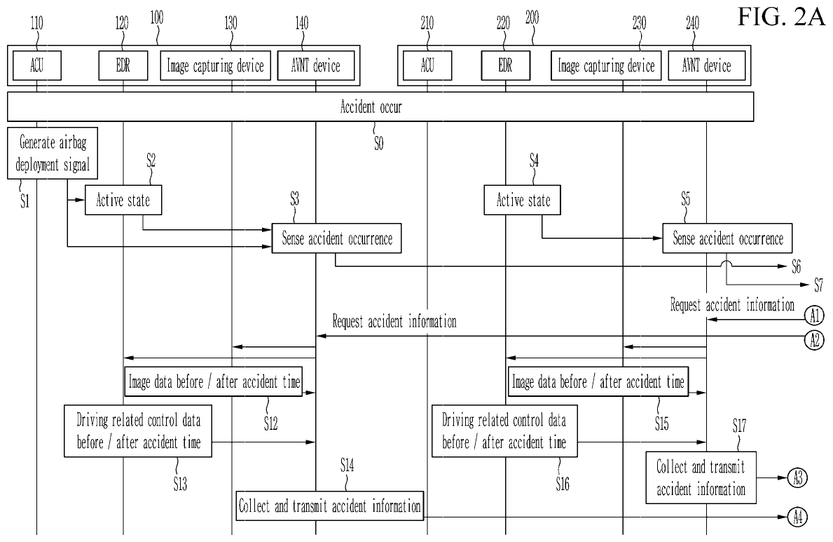

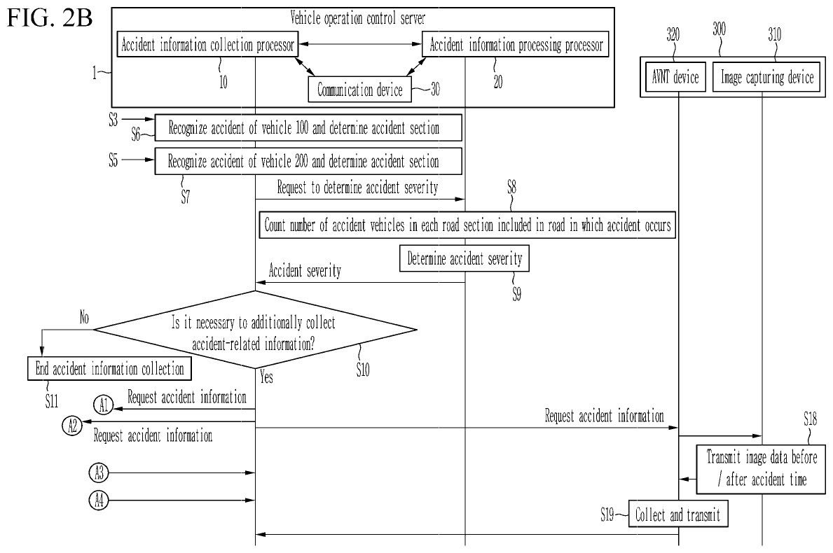

FIGS. 2A and 2B are flowcharts illustrating an operation of a vehicle operation control server.

As illustrated in FIG. 1, a vehicle operation control server (hereinafter, simply referred to as “server”) 1 transmits and receives information to and from a plurality of vehicles 3_1 to 3_n, (n is a natural number of 1 or larger) which is driving via a wireless network. The plurality of vehicles 3_1 to 3_n is vehicles which are capable of performing wireless communication via a network, and for example, may be vehicles installed with a telematics function.

The server 1 includes an accident information collection processor 10, an accident information processing processor 20, and a communication device 30. The “processor” refers to a configuration which processes a calculation operation, a logic operation, and a determination operation to provide at least one function and is implemented by hardware, software or a combination of hardware and software. For example, the processor may be implemented by software, such as tasks, classes, subroutines, processes, objects, execution threads, or programs which are performed in a predetermined region on the memory or hardware, such as field-programmable gate arrays (FPGA) or application-specific integrated circuits (ASIC), of a combination of the software and the hardware. The processor may be included in a computer readable storage medium or partially dispersed to be distributed in a plurality of computers. In FIG. 1, even though the accident information collection processor 10 and the accident information processing processor 20 are provided as separate processors, the present disclosure is not limited thereto so that the accident information collection processor 10 and the accident information processing processor 20 may be implemented to be integrated as one or more processors.

The communication device 30 transmits a request or a control instruction received from the accident information collection processor 10 and the accident information processing processor 20 to a specific vehicle, some vehicles, or an arbitrary vehicle, among the plurality of vehicles 3_1 to 3_n and receives a response of the request or the control instruction from the specific vehicle, some vehicles, or the arbitrary vehicle, among the plurality of vehicles 3_1 to 3_n. The communication device 30 transmits the information received from the vehicles to a corresponding processor between the accident information collection processor 10 and the accident information processing processor 20.

In FIGS. 2A and 2B, a method for collecting accident information from a vehicle (hereinafter, referred to as accident vehicle) involved in the accident (e.g., traffic accident) and a surrounding (e.g., adjacent) vehicle located in the same accident section as the accident vehicle in accordance with the occurring of the accident by the accident information collection processor 10 of the server is illustrated as a flowchart. The surrounding vehicle may refer to a vehicle located in an accident section to which the accident-occurring point belongs or a vehicle which is located in a predetermined distance from the accident-occurring point. A request or a control instruction transmitted from the accident information collection processor 10 to each vehicle and a response transmitted from each vehicle to the accident information collection processor 10 may be transmitted or received by wireless communication between the communication device 30 and a communication device of each vehicle via the network 2. The wireless communication method is not limited and various known wireless communication methods may be applied.

In FIGS. 2A and 2B, it is described that two vehicles 100 and 200 among the plurality of vehicles are accident vehicles and one vehicle 300 is a surrounding vehicle, but the present disclosure is not limited thereto. Even though there are three or more accident vehicles and/or two or more surrounding vehicles, features described with reference to FIGS. 2A and 2B may be applied.

The vehicle 100 includes an airbag control unit (ACU) 110, an event data recorder (EDR) 120, an image capturing device 130, and an audio video navigation telematics (AVNT) device 140. Even though the configurations of the vehicles 100 and 200 have been illustrated in FIGS. 2A and 2B, the configuration of the vehicle 100 is not limited thereto and the vehicles 100 and 200 may not include a device which acquires information about the accident, such as the EDR or the image capturing device (hereinafter, “accident information acquiring device”) or include one or more of them.

The vehicle 200 may include an ACU 210, an EDR 220, an image capturing device 230, and an AVNT device 240.

The EDR may be a device which records data generated from the ACU, a vehicle electronic stability control device (ESC), or an engine electronic control unit (ECU) for a predetermined period. For example, the EDR 220 records various accident and collision information (hereinafter, referred to as “EDR data”, such as a speed of a corresponding vehicle, whether to operate a brake, an engine RPM, whether to fasten a seat belt, a crash severity delta v, an accelerator pedal position, a steering wheel angle, a tire pressure, a transmission gear position, air back deployment data, an operation time of the ESC and maintains the records for a predetermined period.

The image capturing device may be implemented by a surround view monitoring (SVM) system which is an image system monitoring an image in the vicinity of the vehicle or a built-in camp which is a built-in driving image recording device. The image capturing devices 130 and 230 include a plurality of cameras which captures images in front, rear, and sides of the vehicles 100 and 200.

The AVNT device is an example of devices which transmit images acquired by the image capturing device, accident information recorded by the event data recorder, location information acquired by the Global Positioning System (GPS) device, vehicle identification information for identifying the vehicle to the outside via the network. That is, the present disclosure is not limited thereto and the AVNT device may be replaced with another configuration.

The AVNT devices 140 and 240 acquire location information of the vehicle from the GPS device of the vehicles 100 and 200, transmit corresponding information in response to the request from the server 1, and transmit various information related with the occurred accident. The AVNT devices 140 and 240 serve as a communication device of the vehicles 100 and 200.

First, an accident for the vehicles 100 and 200 occurs in step S0. An airbag of the vehicle 100 is deployed by the accident and the ACU 110 senses a deployment state of the airbag to generate an airbag deployment signal in step S1. The ACU 110 transmits the airbag deployment signal to the EDR 120 and the EDR 120 becomes an active state in step S2. The EDR transmits the active state to the AVNT device 140 and the AVNT device 140 senses the active state of the EDR 120 to sense the occurrence of the accident in step S3. The present disclosure is not limited thereto and the AVNT device 140 senses the active state of the EDR 120 and/or the airbag deployment signal from the ACU 110 to sense the occurrence of the accident. The AVNT device 140 senses the active state of the EDR 120 and receives the EDR data from the EDR 120. The AVNT device 140 senses the occurrence of the accident based on the EDR data and/or the airbag deployment signal. The AVNT device 140 may inform the server 1 of the sensing of the occurrence of accident. For example, the AVNT device 140 transmits an accident occurrence signal including information related to the occurrence of the accident to the server 1. The information related to the accident occurrence includes a time of accident of the vehicle 100 and location information about the accident-occurring point. The AVNT device 140 transmits the accident occurrence signal including location information of the vehicle 100 acquired from the GPS device and accident notification information to the server 1.

The EDR 220 of the vehicle 200 is activated by the accident in step S4. Even though the airbag of the vehicle 200 is not deployed by the accident and the ACU 210 does not generate the airbag deployment signal, if an external impact generated on the vehicle 200 is sensed, the EDR 220 may be activated.

The AVNT device 240 senses the active state of the EDR 220 and senses the occurrence of the accident in step S5. The AVNT device 240 senses the active state of the EDR 220 and receives EDR data from the EDR 220. The AVNT device 240 may sense the occurrence of the accident based on the EDR data. The AVNT device 240 informs the server 1 of the sensing of the accident occurrence. For example, the AVNT device 240 transmits the accident occurrence signal including information related to the occurrence of the accident to the server 1. The information related to the occurrence of the accident includes the location information (accident-occurring point) of the vehicle 200. The AVNT device 240 transmits the accident occurrence signal including the location information of the vehicle 200 acquired from the GPS device of the vehicle 200 and accident notification information.

The accident information collection processor 10 receives the accident occurrence signal from the vehicle 100, recognizes the accident occurrence of the vehicle 100, and determines an accident section based on the location information of the vehicle 100 in step S6. Further, the accident information collection processor 10 receives the accident occurrence signal from the vehicle 200, recognizes the accident occurrence of the vehicle 200, and determines an accident section based on the location information of the vehicle 200 in step S7.

The accident information collection processor 10 collects the accident information based on not only the airbag deployment signal, which is directly related to the accident, but also the EDR data. The EDR data includes data determined that it is driven in the vicinity of the accident location such as the operated seatbelt pretensioner or the operated ESC. When the vehicle rapidly decelerates, the seatbelt pretensioner or the ESC operates so that the EDR data needs to be collected on a regular basis.

The accident information collection processor 10 collects the EDR data of the vehicles 100, 200, and 300 on a regular basis. For example, the vehicles 100, 200, and 300 which subscribe to a connected car service provided by the server 1 frequently transmit the EDR data generated in each vehicle. The server 1 may distinguish the accident vehicle from the surrounding vehicle, among the vehicles 100, 200, and 300, based on the airbag deployment signal and the EDR data of each vehicle 100, 200, and 300. For example, the server 1 determines a vehicle from which the airbag deployment signal occurs, among the vehicles having similar GPS information and time information, as an accident vehicle and also determines a vehicle in which the airbag deployment signal is not generated but the seatbelt pretensioner operates, as the accident vehicle.

The accident information collection processor 10 stores link data about the roads (e.g., in a predetermined area) and derives link data corresponding to the location of the accident-occurring vehicle based on the vehicle location information. The roads are divided into predetermined units and identification data is assigned to every unit. The predetermined unit refers to a unit set to identify some section of the road, such as a portion between intersections, and is referred to as a “link”. The accident information collection processor 10 divides the entire road located in the entire region which provides the vehicle operation control service into the links and assigns a corresponding identification ID to each link. The identification ID assigned to each link is referred to as link data. The server 1 receives the accident occurrence signal from the vehicles 100 and 200 and derives link data corresponding to the location where the accident occurs based on the GPS information included in the accident occurrence signal to determine the accident section.

The server 1 determines whether it is necessary to additionally collect the accident-related information based on an EDR data-based accident severity. In order to determine whether it is necessary to collect the accident-related information, the accident information collection processor 10 requires the accident information processing processor 20 to determine the severity of the accident.

The accident information processing processor 20 counts a number of vehicles which encounters the accident during a predetermined searching period in the accident section of the vehicles 100 and 200 based on the accident information received from the accident information collection processor 10 in step S8.

The accident information processing processor 20 divides the entire roads in predetermined intervals based on link data of each of the entire roads located in the entire region which provides the vehicle operation control service. The accident information processing processor 20 divides each section of the entire roads which is divided into a plurality of sections into a plurality of road sections and assigns a corresponding identifier to each road section. One link includes at least one road section.

The accident information processing processor 20 determines vehicles having similar GPS information and time information based on the EDR data as vehicles which encounters the accident in one accident section. The accident information processing processor 20 derives at least one road section (hereinafter, referred to as “accident-occurring road”) in which the accident occurs, among the plurality of road sections based on the GPS information and the accident section of the vehicles 100 and 200. Hereinafter, for the convenience of description, it is considered that the unit of the accident section is a link and a unit of the accident-occurring road is a road section. The accident information processing processor 20 may count the number of accident vehicles in at least one road section included in the accident-occurring road. For example, when the accident information collection processor 10 receives the accident occurrence signal from the vehicle 100, the number of vehicles in the road section corresponding to the accident-occurring location of the vehicle 100 of the road occurring road is increased by one based on the GPS information and the vehicle identification information included in the accident occurrence signal.

Additionally, the accident information processing processor 20 determines the accident-occurring location of the vehicles 100 and 200 based on image data received from the accident vehicles 100 and 200 and the surrounding vehicle 300. The accident information processing processor 20 recognizes a license plate of the accident vehicle from image data received from the accident vehicles 100 and 200 and the surrounding vehicle 300 and counts the number of accident vehicles with the license plate of the accident vehicle as an identification element. The accident information processing processor 20 derives the number of license plates of the accident vehicles based on the image data and counts the number of license plates of the accident vehicles as the number of accident vehicles.

The accident information processing processor 20 searches for a vehicle in which an accident occurs for a predetermined search period with respect to a time of accident of one of the vehicles 100 and 200 which transmits the accident occurrence signal or a vehicle related to the accidents of the vehicles 100 and 200. The accident information processing processor 20 may search with respect to the earliest time among the times of accident. For example, the accident information processing processor 20 searches for the accident vehicle which encounters the accident within a predetermined search period with respect to the time of accident of the vehicle 100. The search period is set to include a predetermined period before and after the time of accident detected from the accident-occurring signal from the vehicle 100.

For the purpose of the detailed description of one or more example embodiments, it is assumed that the accident of the vehicle 200 occurs with respect to the time of accident of the vehicle 100. For example, when an accident-occurring road of the vehicle 100 is a first road section and an accident-occurring road of the vehicle 200 is a second road section, if the second road section is equal to the first road section, the accident information processing processor 20 counts that there are two vehicles which encounter the accident in the first road section. If the second road section is different from the first road section, the accident information processing processor 20 counts that there is one vehicle which encounters the accident in the first road section and there is one vehicle which encounters the accident in the second road section.

Hereinafter, one accident-occurring road will be described by assuming that the accident-occurring road of the vehicle 100 is the same as the accident-occurring road of the vehicle 200. However, the present disclosure is not limited thereto and the server 1 performs the operation to be described below on each of the plurality of accident-occurring roads.

The accident information processing processor 20 determines an accident severity (e.g., an accident severity value) in step S9. The accident severity may be a value obtained by quantifying the scale of the accident and a damage level according to the accident. The larger the accident severity, the larger the scale and the damage level of the degree. The accident information processing processor 20 determines the accident scale based on the number of vehicles whose airbags are deployed. Information for the accident information processing processor 20 to determine the severity includes a number of accident vehicles in the accident-occurring road, a number of vehicles whose airbags are deployed, among the accident vehicles, a number of vehicles which suddenly stop (e.g., decelerate at a rate greater than a threshold deceleration rate) among the accident vehicles, and an ESC operation time of the accident vehicle. Here, the ESC operation time include a length of the section in which the ESC operates, an interval between a preceding operation and a subsequent operation when the ESC performs the subsequent operation after the preceding operation, and a length of a section in which the subsequent operation is performed. A vehicle in which a seatbelt pretensioner of the vehicle operates may be included in a sudden-stop vehicle among the accident vehicles.

The accident information processing processor 20 analyzes image data acquired from the accident vehicle and the surrounding vehicle among vehicles which encounter the accident on the same road to determine the accident severity in the accident section. For example, when there is one vehicle which encounters the accident in the accident section, the accident information processing processor 20 determines the severity to 1, which is the lowest level and when there are two vehicles which encounters the accident in the accident section, the accident information processing processor 20 determines the accident severity to 2.

When the accident-occurring road includes a plurality of road sections including a plurality of accident-occurring locations and the plurality of road sections is adjacent in a predetermined distance or a plurality of number of road sections, the accident information processing processor 20 determines the accident severity by adding the number of accident vehicles in the adjacent road section. For example, if there are road sections A, B, and C which are sequentially adjacent to each other and there are road sections D, E, and F which are sequentially adjacent to each other, one vehicle encounters the accident on the road section A, one vehicle encounters the accident on the road section B, and no vehicle encounters the accident on the road section C, no vehicle encounters the accident on the road section D, one vehicle encounters the accident on the road section E, and no vehicle encounters the accident on the road section F, there are two accident vehicles in three adjacent road sections A to C, so that the accident severity is determined to be 2. Further, there is one accident vehicle in the three adjacent road sections D to F, so that the accident severity is determined to be 1.

The accident information processing processor 20 determines whether the airbag is deployed using an airbag deployment signal generated by the ACU of each vehicle for at least one road section of the accident-occurring road.

The accident information processing processor 20 determines whether a number of accident vehicles in one road section is single or plural. When the accident vehicle is single, the accident information processing processor 20 determines the severity depending on whether the airbag of the vehicle is deployed. For example, when the accident vehicle is one and the airbag is not deployed, the accident information processing processor 20 determines the accident severity to be 1 which is the lowest level. When there is one accident vehicle in one road section and the airbag is deployed, the accident information processing processor 20 determines the accident severity to 2.

When there is a plurality of accident vehicles in one road section, the accident information processing processor 20 may determine the accident severity depending on the number of vehicles whose airbag is deployed, among the plurality of vehicles. For example, when there are two accident vehicles in one road section and both airbags are not deployed, the accident information processing processor 20 determines the accident severity to 2. When there are two accident vehicles in one road section and an airbag of one of two vehicles is deployed, the accident information processing processor 20 determines the accident severity to 3. When there are two accident vehicles in one road section and both airbags of two vehicles are deployed, the accident information processing processor 20 determines the accident severity to 4.

The accident information processing processor 20 increases the accident severity according to a number of suddenly stopped vehicles, among the accident vehicles in one road section by a predetermined unit. For example, when there are two accident vehicles in one road section, both airbags of two vehicles are deployed and one vehicle suddenly stops, the accident information processing processor 20 determines the accident severity to 5. In order to determine whether to suddenly stop, the accident information processing processor 20 uses information indicating whether an operation of the ESC before the sudden stop acquired by the EDR is triggered. For example, the accident information processing processor 20 may determine a vehicle in which the operation of the ESC is triggered to suddenly stop.

The accident information processing processor 20 may determine the accident severity according to a slippery section of the road in one road section. The accident information processing processor 20 uses ESC operation time data acquired by the EDR to determine the slippery section of the road. When a length of a slippery section in one read section in which the ESC of the accident vehicle which encounters the accident operates is equal to or longer than a predetermined first threshold value, the accident information processing processor 20 determines the accident severity to 2. When the ESC performs a subsequent operation after a preceding operation, if a length of the slippery section in which the subsequent operation is performed is equal to or longer than the predetermined second threshold value, the accident information processing processor 20 determines to increase the accident severity to 3.

The accident information processing processor 20 transmits data indicating the determined accident severity to the accident information collection processor 10.

The accident information collection processor 10 determines whether it is necessary to additionally collect the accident related information based on the accident severity in step S10. When the accident information collection processor 10 receives the accident occurrence signal, but cannot acquire the accident information from the vehicle which transmits the accident occurrence signal or information required to accurately identify the accident is further required, the accident information collection processor 10 determines that it is necessary to additionally collect the accident related information. When the accident is accurately identified, it means to determine accident details and a damage degree such as whether it is just an accident or a collision accident between two or more vehicles, whether there is an additional vehicle related to the same accident, whether it is a simple minor collision, a degree of a damage and a life damage due to the collision between vehicles.

The accident information collection processor 10 compares the accident severity to a predetermined threshold level to determine that it is necessary to additionally collect accident related information. Optionally, the step S10 is not performed and the accident information collection processor 10 may perform an operation for additionally collecting the accident related information without performing the step S10. As a result of determination in step S10, if the accident severity is lower than the predetermined threshold level, the accident information collection processor 10 determines that it is not necessary to additionally collect the accident related information to end the collection of the accident information in step S11.

When in step S10, if the accident severity is equal to or higher than the predetermined threshold level, the accident information collection processor 10 determines that the additional accident related information is necessary. When the accident information collection processor 10 informs the other vehicles of only the accident occurrence and the accident section, the additional accident related information is not necessary. The server 1 may operate in a different manner depending on the accident severity so that it is determined that the additional accident related information is necessary.

As a result of determination in the step S10, when the accident related information needs to be additionally collected, the server 1 requests the vehicles 100 and 200 the accident information. The requested accident information may include detail data about the accident acquired by the EDR equipped in the vehicle and image data of the built-in camera equipped in the vehicle. The detail data about the accident acquired by the EDR includes operation time data of the ESC.

If it is assumed that there is no separate device to collect accident related information other than the ACU 110 in the vehicle which receives the accident information request from the server 1, the AVNT device informs the server 1 of the information acquisition failure that the accident information cannot be acquired.

The server 1 transmits the accident information request to the vehicle 100. The AVNT device 140 of the vehicle 100 receives the accident information request from the server 1, requests the image capturing device 130 image data within a predetermined time range before/after the accident time and requests EDR 120 driving related control data within a predetermined time range before/after the accident time.

In response to the request, the image capturing device 130 transmits the image data within a predetermined time range before/after the accident time to the AVNT device 140 in step S12 and the EDR 120 transmits driving related control data within the predetermined time range before/after the accident time to the AVNT device 140 in step S13.

The AVNT device 140 collects the accident information received from the image capturing device 130 and the EDR 120 to transmit the collected accident information to the server 1 in step S14.

As described above, when the vehicles 100 and 200 include one or more accident information acquiring devices, the AVNT devices 140 and 240 request at least one accident information acquiring device the accident information data within a predetermined range before/after the accident time and collect at least one accident information data from at least one accident information acquiring device to transmit the collected accident information data to the server 1. Here, at least one accident information data refers to image data or driving related control data generated within the accident time before/after the accident time by at least one accident information acquiring device.

The server 1 transmits the accident information request to the vehicle 200. The AVNT device 240 of the vehicle 200 receives the accident information request from the server 1, requests the image capturing device 230 image data within the predetermined time range before/after the accident time, and requests the EDR 220 the driving related control data within a predetermined time range before/after the accident time.

As a response to the request, the image capturing device 230 transmits the image data to the AVNT device 240 within the predetermined time range before/after the accident time in step S15 and the EDR 220 transmits the accident-related control data to the AVNT device 240 within the predetermined time range before/after the accident time in step S16.

The AVNT device 240 collects the accident information received from the image capturing device 230 and the EDR 220 to transmit the collected accident information to the server 1 in step S17.

In step S10, when the accident information collection processor 10 determines that it is necessary to additionally collect the accident-related information, the accident information collection processor 10 requests not only a vehicle which transmits the accident occurrence signal, but also a surrounding vehicle 300 which drives in the vicinity of the vehicles 100 and 200 in the accident occurrence section the accident information.

When the accident information collection processor 10 determines that it is necessary to additionally collect the accident-related information in step S10, the server 1 transmits the accident information request to the vehicle 300. The AVNT device 320 of the vehicle 300 receives the accident information request from the server 1 and requests the image capturing device 310 the image data within a predetermined time range before/after the accident time. The AVNT device 320 of the vehicle 300 requests the EDR of the vehicle 300 the driving related control data within the predetermined time range before/after the accident time.

In response to the request, the image capturing device 310 transmits the image data to the AVNT device 320 within the predetermined time range before/after the accident time in step S18 and the AVNT device 320 collects the received image data to transmit the image data to the server in step S19. In response to the request, the EDR of the vehicle 300 may transmit the driving related control data to the AVNT device 320 or the AVNT device 320 collects the received image data and accident data to transmit the collected image data and accident information to the server 1 within the time range before/after the accident time.

The accident information processing processor 20 receives the collected accident information from the accident information collection processor 10 and determines an accident response measure for the following vehicle (also referred to as a trailing vehicle) according to the accident information. For example, the accident information processing processor 20 determines the accident severity indicating the seriousness of the accident based on the accident information, determines the accident response measurement for the following vehicle according to the accident severity, and transmits the determined measurement to the following vehicle. The following vehicle refers to a vehicle which follows the accident vehicle by a predetermined distance on the driving path with respect to the accident-occurring location.

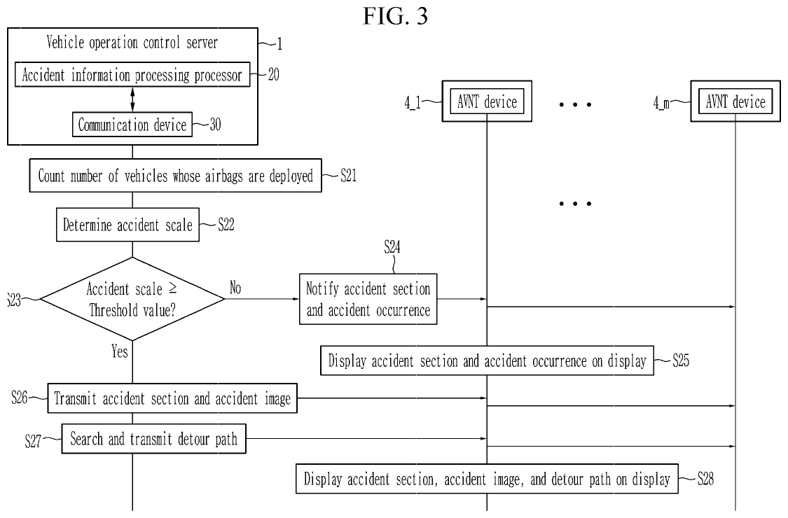

FIG. 3 is a flowchart illustrating an accident information processing method of a server.

In FIG. 3, a plurality of following vehicles 4_1 to 4_m (m is a natural number of 1 or larger) is illustrated and each of the plurality of following vehicles includes an AVNT device.

The accident information processing processor 20 counts a number of vehicles whose air bags are deployed for a predetermined search period in at least one road section included in the accident-occurring road based on the accident information received from the accident information collection processor 10 in step S21. The accident information processing processor 20 counts the number of vehicles whose airbags are deployed from the accident severity.

The accident information processing processor 20 determines the accident scale based on the number of vehicles whose airbags are deployed in step S22. The accident information processing processor 20 determines that the more the number of vehicles whose airbags are deployed, the larger the accident scale.

The accident information processing processor 20 may compare the accident scale with a predetermined threshold value which is a reference of determining the severity of the accident in step S23.

The accident information processing processor 20 determines whether the accident scale is equal to or larger than the threshold value. For example, when the number of vehicles whose airbags are deployed on the accident-occurring road is three or more, the accident information processing processor 20 determines that the accident scale is equal to or higher than the threshold value.

As a result of determination in step S23, if the accident scale is lower than the threshold value, the accident information processing processor 20 notifies the following vehicles 4_1 to 4_m of the accident period and the accident occurrence in step S24. Specifically, the accident information processing processor 20 transmits an accident notification to the communication device 30 together with information indicating the accident section (accident section information) and the communication device 30 transmits them to the following vehicles 4_1 to 4_m via the network 2 in step S24. The following vehicles 4_1 to 4_m display the accident section and the accident occurrence on the display equipped in the vehicle in step S25.

As a result of determination in step S23, if the accident scale is equal to or larger than the threshold value, the accident information processing processor 20 transmits the accident section and the accident image to the following vehicles 4_1 to 4_m in step S26. Specifically, the accident information processing processor 20 transmits the acquired accident image data acquired from the image capturing device of the accident vehicle and the surrounding vehicle together with the information indicating the accident section (accident section information) to the communication device 30 and the communication device 30 transmits the accident image data and the information to the following vehicles 4_1 to 4_m via the network 2. The accident information processing processor 20 searches a detour path for bypassing the accident section and transmits at least one searched detour path to the following vehicles 4_1 to 4_m in step S27.

The following vehicles 4_1 to 4_m display the accident section, an accident image, and a detour path on a display equipped in the vehicle in step S28.

As described above, the server may recognize the occurrence of the accident and acquires accident information from not only the accident vehicle, but also the surrounding (e.g., adjacent) vehicle to transmit the accident information to the following vehicle.

Although an operation example of the server has been described in detail until now, it just describes the present disclosure, but the claims of the present disclosure is not limited by the one or more example embodiments described herein. It is understood by those skilled in the art that various changes and equivalent example embodiments are possible from the present disclosure. Accordingly, the true technical scope of the present disclosure needs to be determined by the technical spirit of the appended claims.

What is claimed is:

1. A server device comprising:
a communication device configured to exchange, via a network, information with a vehicle;
one or more processors; and
memory storing instructions that, when executed by the one or more processors, cause the server device to:
collect, via the communication device and from one or more vehicles in a road section, event data regarding a traffic accident associated with the road section;
determine, based on the event data and among the one or more vehicles, a quantity of vehicles that had at least one airbag deployed in connection with the traffic accident;
determine, based on the quantity of the vehicles that had at least one airbag deployed in connection with the traffic accident, an accident severity value indicating seriousness of the traffic accident;
transmit, via the communication device and based on the accident severity value, a notification to a trailing vehicle that trails behind the one or more vehicles; and
collect, based on a determination that the accident severity value satisfies a threshold value, additional information associated with the traffic accident.

2. The server device of claim 1, wherein, to collect the event data, the instructions, when executed by the one or more processors, cause the server device to:
divide, based on link data for one or more roads, one or more roads into a plurality of road sections;
determine, among the plurality of road sections, the road section on which the traffic accident occurred; and
determine a quantity of the one or more vehicles in the road section.

3. The server device of claim 1, wherein the instructions, when executed by the one or more processors, cause the server device to:
search, among the one or more vehicles in the road section, for a vehicle that encounters the traffic accident during a predetermined search period.

4. The server device of claim 2, wherein the instructions, when executed by the one or more processors, cause the server device to determine the accident severity value further based on at least one of: the quantity of the one or more vehicles in the road section, a quantity of vehicles that decelerated at a rate above a threshold deceleration rate, or a quantity of vehicles with an operation time of an electronic stability control (ESC) device above a threshold time duration.

5. The server device of claim 1, wherein the instructions, when executed by the one or more processors, cause the server device to determine the accident severity value further based on additional event data from one or more additional vehicles in additional road sections that are adjacent to the road section.

6. The server device of claim 1, wherein the instructions, when executed by the one or more processors, further cause the server device to determine the road section based on location information of the one or more vehicles.

7. The server device of claim 1, wherein the additional information associated with the traffic accident comprises at least one of: image data associated with the one or more vehicles, driving-related control data associated with the one or more vehicles, or image data associated with vehicles adjacent to the one or more vehicles.

8. The server device of claim 1, wherein the instructions, when executed by the one or more processors, further cause the server device to estimate, based on the quantity of vehicles that had at least one airbag deployed in connection with the traffic accident, a scale of the traffic accident.

9. The server device of claim 1, wherein the instructions, when executed by the one or more processors, further cause the server device to, based on the scale of the traffic accident being greater than a second threshold value:
transmit, to the trailing vehicle:
an accident section notification indicating the road section, and
an image associated with the traffic accident;
search for a detour path around the road section; and
transmit, via the communication device, the searched detour path to the trailing vehicle.

10. The server device of claim 1, wherein the instructions, when executed by the one or more processors, further cause the server device to, based on the scale of the traffic accident being less than a second threshold value, transmit, via the communication device and to the trailing vehicle:
an accident notification indicating occurrence of the traffic accident, and
an accident section notification indicating the road section.

11. The server device of claim 1, wherein the communication device is further configured to receive recorded data from an audio video navigation telematics (AVNT) device of each of the one or more vehicles.

12. A method comprising:
receiving, by a server device and from one or more vehicles, a signal indicating a traffic accident, the signal comprising event data generated by a respective event data recorder of each of the one or more vehicles;
determining, based on the signal, one or more road sections where the traffic accident occurred;
determining, based on a location of the traffic accident, a quantity of vehicles, of the one or more vehicles, in at least one road section of the one or more road sections;
determining, based on the event data and the quantity of the vehicles in the at least one road section, an accident severity value indicating seriousness of the traffic accident;
determining, based on the accident severity value, whether to collect additional information associated with the traffic accident;
estimating, based on a quantity of vehicles whose airbags were deployed, a scale of the traffic accident; and
transmitting, based on the estimated scale of the traffic accident, a notification, associated with the traffic accident, to a trailing vehicle that trails behind the one or more vehicles.

13. The method of claim 12, wherein the determining the quantity of the vehicles in the at least one road section comprises:
dividing, based on link data for one or more roads, the one or more roads into the road sections;
determining, among the road sections, the at least one road section in which the traffic accident occurred; and
determining the quantity of the vehicles in the at least one road section.

14. The method of claim 12, wherein the determining the quantity of the vehicles in the at least one road section comprises:
searching, among the one or more vehicles in the at least one road section, for a vehicle that encounters the traffic accident during a predetermined search period.

15. The method of claim 12, wherein the determining the accident severity value comprises:
determining the accident severity value further based on at least one of: the quantity of vehicles whose airbags were deployed, a quantity of vehicles that decelerated at a rate above a threshold deceleration rate, or a quantity of vehicles with an operation time of an electronic stability control (ESC) device above a threshold time duration.

16. The method of claim 12, further comprising:
based on determining to collect the additional information, requesting the one or more vehicles and at least one adjacent vehicle for the additional information.

17. The method of claim 12, wherein the additional information associated with the traffic accident comprises at least one of: image data associated with the one or more vehicles, driving-related control data associated with the one or more vehicles, or image data associated with vehicles adjacent to the one or more vehicles.

18. The method of claim 12, wherein, based on the estimated scale of the traffic accident being less than a second threshold value, the notification comprises: an indication of the traffic accident and an indication of the at least one road section.

19. The method of claim 12, wherein, based on the estimated scale of the traffic accident being greater than or equal to a second threshold value, the notification comprises:
an indication of the at least one road section and an image associated with the traffic accident, and
wherein the method further comprises:
searching for a detour path around the at least one road section; and
transmitting the searched detour path to the trailing vehicle.
